(19) United States
(12) Patent Application Publication
(10) Pub. No.: US 2006/0165278 A1
(43) Pub. Date: Jul. 27, 2006

(54) Image signal processing device

(76) Inventors: Tomohiro Uryu, Osaka (JP); Hideaki Kawamura, Shiga (JP)

Correspondence Address: RATNERPRESTIA, P.O. BOX 980, VALLEY FORGE, PA, 19482, US

(21) Appl. No.: 10/563,509

(22) PCT Filed: May 24, 2005
(86) PCT No.: PCT/JP05/09833

§ 371 Date: Jan. 5, 2006

(30) Foreign Application Priority Data
May 24, 2004 (JP) 2004-152805

(51) Int. Cl. G06K 9/00; G09G 3/10

(52) U.S. Cl. 382/162; 345/42

(57) ABSTRACT

An image signal processing device has an LSI including a ROM access control circuit for holding data for controlling an operation of a video signal processing unit, and a flush ROM that is disposed outside the LSI, holds control data to be transmitted to the ROM access control circuit, and allows data read to be controlled by the ROM access control circuit. The data transferred between the flush ROM and the ROM access control circuit has data that must be updated every field and data that does not need to be updated every field. The data is transferred in a vertical blanking time period of the video output data. This configuration allows certain transfer of required data using the vertical blanking time period.

### TECHNICAL FIELD

The present invention relates to an image signal processing device such as a plasma display.

### BACKGROUND ART

An alternating-current surface discharge type panel typical as a plasma display panel (hereinafter referred to as “panel”) has many discharge cells between a front plate and a back plate that are faced to each other. The front plate has the following elements:

a plurality of display electrode pairs disposed in parallel on a front glass substrate; and

a dielectric layer and protective layer for covering the display electrode pairs.

Here, each display electrode pair is formed of a pair of scan electrode and sustain electrode. The back plate has the following elements:

a plurality of data electrodes disposed in parallel on a back glass substrate;

a dielectric layer for covering the data electrodes;

a plurality of barrier ribs disposed on the dielectric layer in parallel with the data electrodes; and

phosphor layers disposed on the front surface of the dielectric layer and on side surfaces of the barrier ribs. The front plate and back plate are faced to each other so that the display electrodes and the data electrodes three-dimensionally intersect, and are sealed. Discharge gas is filled into a discharge space in the sealed product. Discharge cells are formed at the parts where the display electrodes and the data electrodes intersect. In the panel having this configuration, ultraviolet rays are emitted by gas discharge in each discharge cell. The ultraviolet rays excite respective phosphors of red, blue, and green, emit light, and thus provide color display.

A subfield method is generally used as a method of driving the panel. In this method, one field time period is divided into a plurality of subfields, and the subfields at which light is emitted are combined, thereby performing gradation display. Of the subfield methods, a new driving method that reduces increase of black luminance by minimizing light emission that is not related to a gradation representation and improves the contrast ratio is disclosed in Japanese Patent Unexamined Publication No. 2000-242224.

An image signal processing device employed for driving and controlling this type of plasma display, generally, has the following elements:

a semiconductor integrated circuit (LSI) for processing a video signal; and

a flush read only memory (ROM) that is disposed outside the LSI and is used as an external memory for holding data for controlling an operation of the LSI.

The image signal processing device performs data communication between a ROM access control circuit in the LSI and the flush ROM. The ROM access control circuit in the LSI generates a ROM address signal and a ROM enabling signal, and transfers these signals to the flush ROM. The flush ROM, on receiving the signals, transfers previously held ROM data for operation control to the ROM access control circuit.

Recently, as the need for increase of the image quality of a display device intensifies, the data amount of the flush ROM for controlling an operation of the LSI increases. Signals of various formats are required to be input to the display device, and thus the vertical blanking time period can shorten. In this case, disadvantageously, all data required for controlling the operation of the LSI cannot be transferred in the vertical blanking time period.

### SUMMARY OF THE INVENTION

The present invention addresses the problems caused by the increase of the image quality and the input of the signals of various formats, in an image signal processing device.

The image signal processing device has the following elements:
a semiconductor integrated circuit having a video signal processing unit for outputting video output data to a display device and a control unit for holding data for controlling an operation of the video signal processing unit; and
an external memory that is disposed outside the semiconductor integrated circuit, holds control data to be fed to the control unit, and allows the data read to be controlled by the control unit.
   The data transferred between the external memory and the control unit has data that must be updated every field and data that does not need to be updated every field, and is transferred in a vertical blanking time period of the video output data. The data that does not need to be updated every field is divided into a plurality of data, assigned to a plurality of fields, and transferred.

In the image signal processing device of the present invention, the video signal processing unit has a memory for holding the data that must be updated every field and a memory for holding the data that does not need to be updated every field.

The present invention allows data transfer between the external memory and the control unit during the vertical blanking time period even when control data for driving the display unit increases.

### BRIEF DESCRIPTION OF THE DRAWINGS

FIG. 1 is a perspective view showing an essential part of a panel of a plasma display in accordance with an exemplary embodiment of the present invention.

FIG. 2 is an electrode array diagram of the plasma display panel.

FIG. 3 is an overall block diagram of the plasma display panel.

FIG. 4 is a block diagram showing an image signal processing device in accordance with the exemplary embodiment of the present invention.

FIG. 5 is a diagram illustrating data transfer in the image signal processing device.

FIG. 6 is a diagram illustrating one example where the data is divided into two and transferred in the image signal processing device.

FIG. 7 is a diagram illustrating one example where the data is divided into four and transferred in the image signal processing device.

### DETAILED DESCRIPTION OF PREFERRED EMBODIMENTS

An image signal processing device in accordance with the exemplary embodiment of the present invention, a plasma display for example, will be described hereinafter with reference to the following drawings.

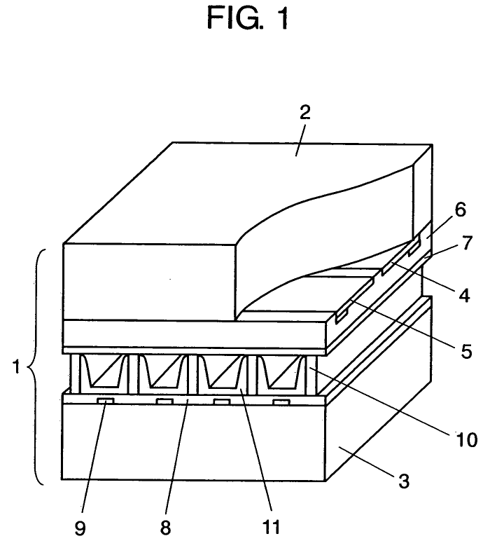

FIG. 1 is a perspective view showing an essential part of a panel used for a plasma display in accordance with an exemplary embodiment of the present invention. Panel 1 has glass-made front substrate 2 and back substrate 3 that are faced to each other, and a discharge space is formed between them. In the view from the front substrate 2 side, a plurality of pairs of scan electrodes 4 and sustain electrodes 5 that form display electrodes are formed in parallel on front substrate 2. Dielectric layer 6 is formed so as to cover scan electrodes 4 and sustain electrodes 5, and protective layer 7 is formed on dielectric layer 6. A plurality of data electrodes 9 covered with insulator layer 8 are disposed on back substrate 3, and barrier ribs 10 are disposed on insulator layer 8 between data electrodes 9 and in parallel with data electrodes 9. Phosphor layers 11 are disposed on the front surface of insulator layer 8 and on side surfaces of barrier ribs 10. Front substrate 2 and back substrate 3 are faced to each other in the intersecting direction of scan electrodes 4 and sustain electrodes 5 with data electrodes 9. Discharge spaces formed between front substrate 2 and back substrate 3 are filled with discharge gas such as mixed gas of neon and xenon.

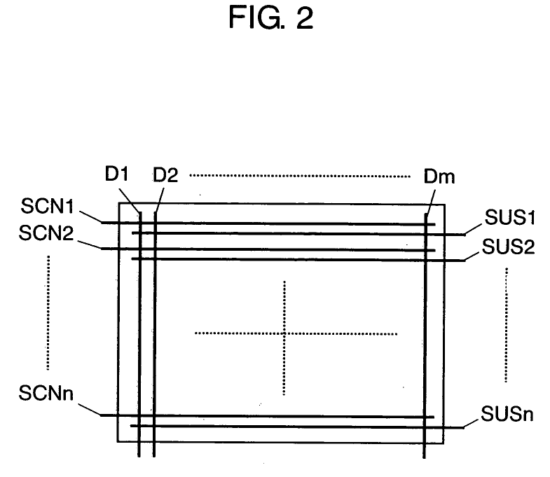

FIG. 2 is an array diagram of electrodes of the panel. In the row direction, n rows of scan electrodes SCN1 to SCNn (scan electrodes 4 in FIG. 1) and n rows of sustain electrodes SUS1 to SUSn (sustain electrodes 5 in FIG. 1) are alternately arranged. In the column direction, m columns of data electrodes D1 to Dm (data electrodes 9 in FIG. 1) are arranged. A discharge cell is formed in a part where one pair of scan electrode SCNi and sustain electrode SUSi (i=1 to n) cross one data electrode Dj (j=1 to m). Total number of discharge cells formed in the discharge spaces is m×n.

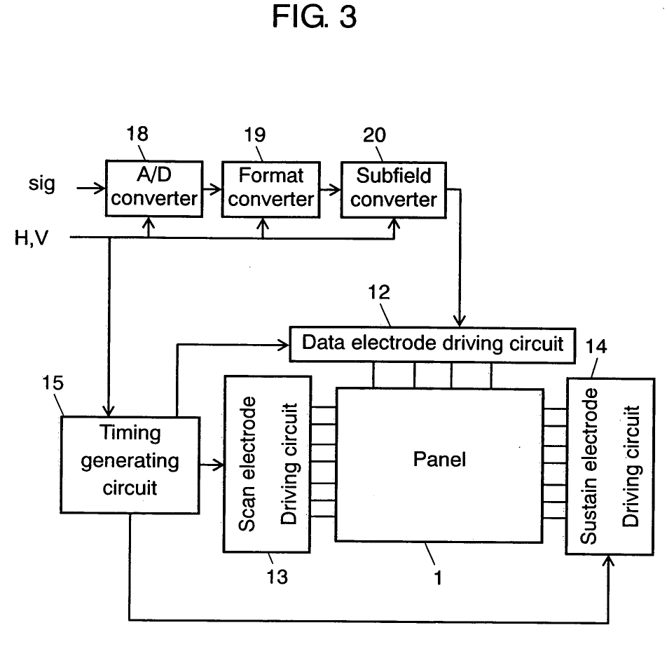

FIG. 3 is an overall block diagram of the plasma display panel. The plasma display panel has the following elements:
panel 1;
data electrode driving circuit 12;
scan electrode driving circuit 13;
sustain electrode driving circuit 14;
timing generating circuit 15;
analog-digital (AD) converter 18;
format converter 19;
subfield converter 20; and
power supply circuit (not shown).

In FIG. 3, image signal sig is fed into AD converter 18. Horizontal synchronizing signal H and vertical synchronizing signal V are supplied to timing generating circuit 15, AD converter 18, format converter 19, and subfield converter 20. AD converter 18 converts image signal sig to image data as a digital signal, and supplies the image data to format converter 19. Format converter 19 converts the image data to image data corresponding to the number of pixels of panels 1, and supplies it to subfield converter 20. Subfield converter 20 divides the image data of each pixel to a plurality of bits corresponding to a plurality of subfields, and outputs the image data in each subfield to data electrode driving circuit 12. Data electrode driving circuit 12 converts the image data in each subfield to a signal corresponding to each of data electrodes D1 to Dm, and drives each data electrode.

Timing generating circuit 15 generates a timing signal based on horizontal synchronizing signal H and vertical synchronizing signal V, and supplies it to scan electrode driving circuit 13 and sustain electrode driving circuit 14. Scan electrode driving circuit 13 supplies a driving waveform to scan electrodes SCN1 to SCNn based on the timing signal. Sustain electrode driving circuit 14 supplies a driving waveform to sustain electrodes SUS1 to SUSn based on the timing signal.

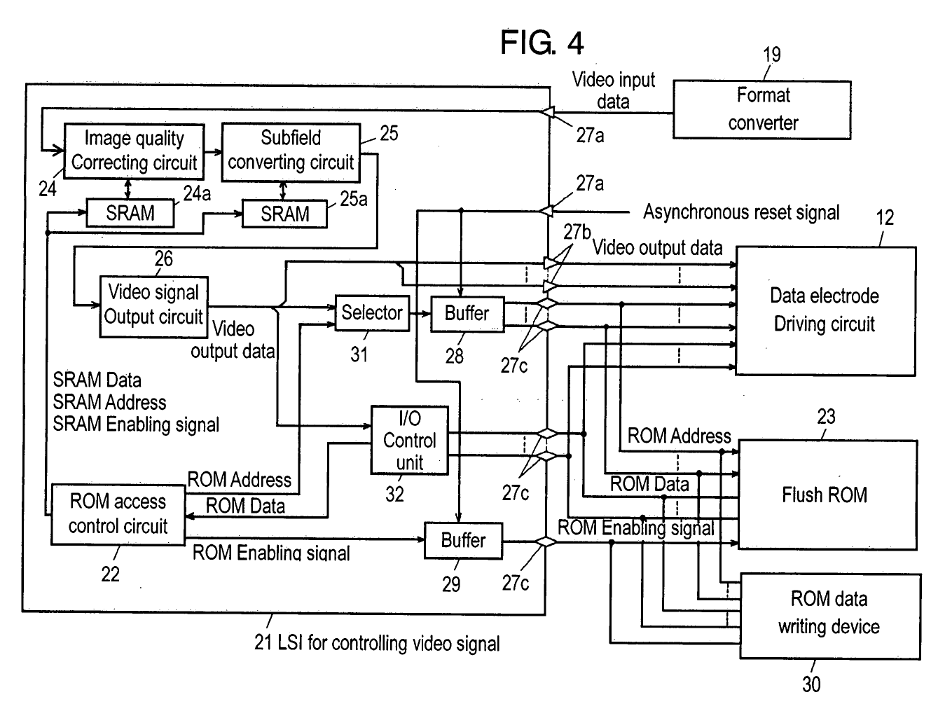

FIG. 4 is a block diagram showing a detailed driving circuit part of the plasma display in accordance with the exemplary embodiment of the present invention. In FIG. 4, the driving circuit part of the plasma display has the following elements:

LSI 21 for processing a video signal, namely a semiconductor integrated circuit, that outputs video output data to data electrode driving circuit 12 of the panel as the display device; and

flush ROM 23 that is connected to LSI 21, and is an external memory for transmitting or receiving the control data from ROM access control circuit 22 as a control unit in LSI 21.

A video signal processing unit is disposed in LSI 21. The video signal processing unit has the following elements:

image quality correcting circuit 24 that receives video input data transmitted from format converter 19 and performs signal processing of image quality correction;

subfield converting circuit 25 for generating a signal in each subfield based on the output data of image quality correcting circuit 24; and

video signal output circuit 26 for generating video output data based on the signal transmitted from subfield converting circuit 25.

Operations of image quality correcting circuit 24 and subfield converting circuit 25 of the video signal processing unit are controlled based on ROM data that is read by ROM access control circuit 22 and is held in the flush ROM. Image quality correcting circuit 24 and subfield converting circuit 25 of the video signal processing unit have static random access memory (SRAM) 24a and SRAM 25a, respectively. SRAM 24a and SRAM 25a are memories for holding ROM data transmitted for controlling the operations of respective circuits.

In other words, data to be required by image quality correcting circuit 24 and subfield converting circuit 25 is stored in flush ROM 23 outside LSI 21, and is taken into LSI 21 every field during the vertical blanking time period. ROM access control circuit 22 generates a ROM address signal and a ROM enabling signal, and transfers these signals to flush ROM 23. Flush ROM 23, on receiving the signals, transfers the signal of the ROM data to ROM access control circuit 22. The transferred ROM data is held in SRAMs 24a and 25a of image quality correcting circuit 24 and subfield converting circuit 25, and the operations of image quality correcting circuit 24 and subfield converting circuit 25 are controlled based on the ROM data.

LSI 21 has input terminal 27a for data input to LSI 21, output terminal 27b for data output, and input/output terminal 27c for data input/output. The video output data supplied from video signal output circuit 26 is transmitted to data electrode driving circuit 12 of the display device through output terminal 27b and input/output terminal 27c. ROM access control circuit 22 is connected to flush ROM 23 outside LSI 21 through input/output terminal 27c. A part of input/output terminal 27c is connected to both data electrode driving circuit 12 of the display device and flush ROM 23.

In LSI 21, buffers 28 and 29 controlled by an asynchronous reset signal transmitted from input terminal 27a of LSI 21 are inserted into the lines for transferring the ROM address signal and the ROM enabling signal from ROM access control circuit 22 of LSI 21 to flush ROM 23. Buffers 28 and 29 open the ROM address signal and the ROM enabling signal while the asynchronous reset signal is enabled. Enabling the asynchronous reset signal allows other ROM data writing device 30 to update the data contents in flush ROM 23 during the enabling.

In LSI 21, the video output data supplied from video signal output circuit 26 is transmitted to data electrode driving circuit 12 of the display device through the following lines:

a line for transferring the data from output terminal 27b to data electrode driving circuit 12 of the display device;

a line that is common with that for the signal of the ROM address from ROM access control circuit 22 and transfers the data from input/output terminal 27c to data electrode driving circuit 12 of the display device through selector 31 and buffer 28; and

a line that is common with that for the signal of the ROM data transferred from flush ROM 23 to ROM access control circuit 22 and transfers the data from input/output terminal 27c to data electrode driving circuit 12 of the display device through I/O control unit 32 as an input/output control means. In other words, input/output terminal 27c of LSI 21 is used as a terminal for outputting video output data from video signal output circuit 26, and is used as a terminal for transferring the ROM address and the ROM data between ROM access control circuit 22 and flush ROM 23. Each data is multiplexed on the time axis and transmitted.

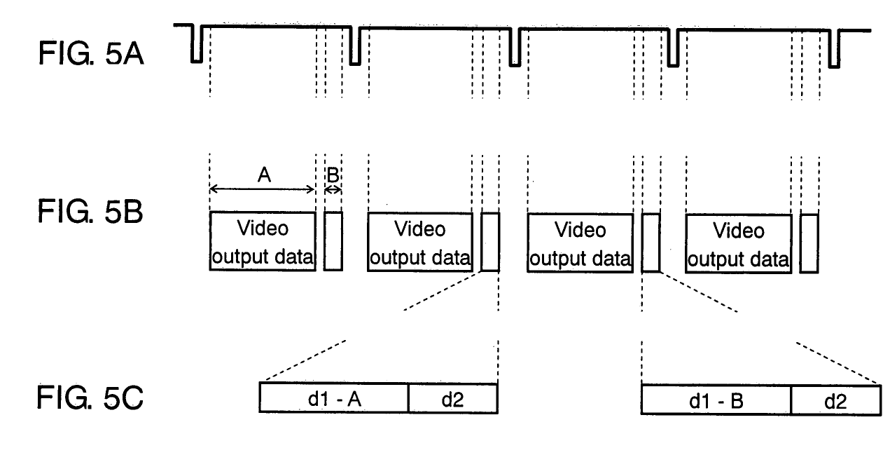

Cases where a ROM address terminal and ROM data terminal of LSI 21 are shared with the output terminal of the video output data of LSI 21 and each data is multiplexed on the time axis and transmitted are described with reference to FIG. 5 to FIG. 7.

FIG. 5A shows a vertical synchronous signal, FIG. 5B shows transfer data between LSI 21 and the display device and between LSI 21 and flush ROM 23, and FIG. 5C shows a data pattern by an example of the ROM data in the transfer data. In FIG. 5, during effective video time period A, the video output data supplied from video signal output circuit 26 inside LSI 21 is transferred to data electrode driving circuit 12 outside LSI 21. While, during vertical blanking time period B, the ROM address signal and the ROM enabling signal are transferred from ROM access control circuit 22 inside LSI 21 to flush ROM 23 outside LSI 21. In response to the ROM address signal and the ROM enabling signal, ROM data formed of data d1-A, d1-B and so on that must be updated every field and data d2 that does not need to be updated every field shown in FIG. 5C is transferred from flush ROM 23 to LSI 21.

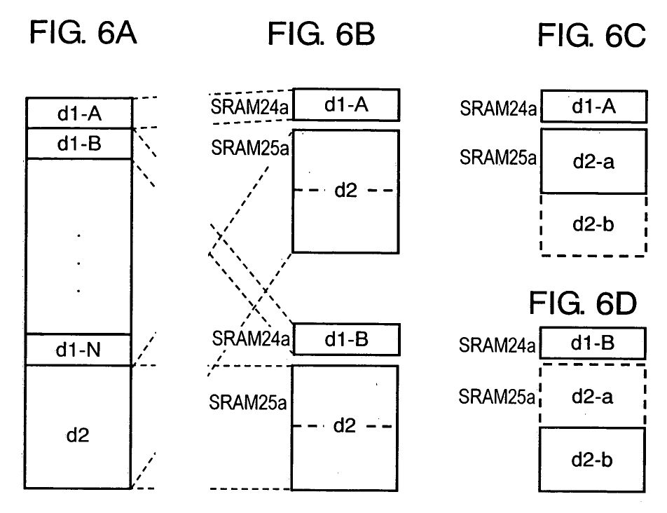

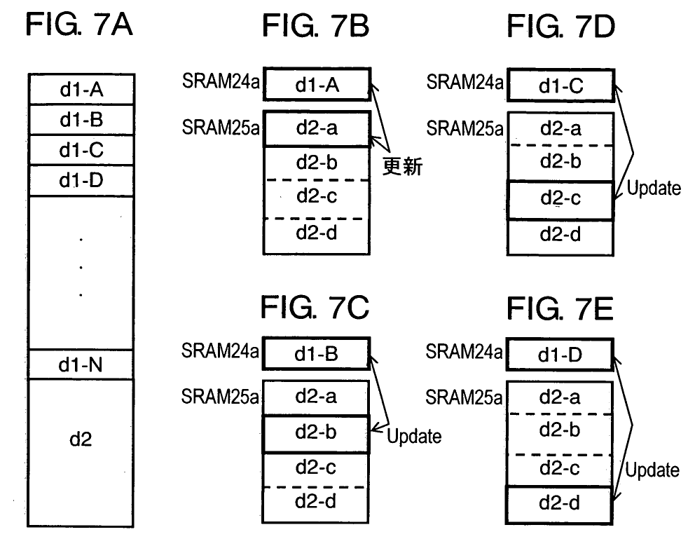

Here, all ROM data must be transferred to LSI 21 within vertical blanking time period B. When data d2 same in every field is divided into a plurality of fields and transferred, the ROM data can be transferred to LSI 21 even within a shorter vertical blanking time period. FIG. 6 and FIG. 7 show a concept of the case where data d2 that does not need to be updated every field is divided into a plurality of data, assigned to a plurality of fields, and transferred.

FIG. 6 illustrates the concept of the case where data d2 same in every field is divided into two data, assigned to two fields, and transferred. FIG. 6A shows ROM data. FIG. 6B shows an un-employed example, where data formed of each of variable data d1-A, d1-B and so on and same data d2 is transferred every field. FIG. 6C and FIG. 6D show an employed example. In FIG. 6C and FIG. 6D, same data d2 is divided into two data d2-a and d2-b, data d2-a is transferred to SRAM 25a when variable data d1-A is transferred to SRAM 24a, and remaining data d2-b is transferred to SRAM 25a when variable data d1-B is transferred to SRAM 24a in the next field. Data d2-a transferred to SRAM 25a when variable data d1-A is transferred in the first field is not updated when variable data d1-B is transferred in the next field, but is held as it is in SRAM 25a. In the next field, only data d2-b is transferred and held in SRAM 25a. When variable data d1-C is transferred in the field after the next, data d2-a and data d2-b held in SRAM 25a are updated as data d2. These data transfers are alternately repeated, and thus same data d2 is divided every field and is transferred to SRAM 25a.

FIG. 7 illustrates a case where same data d2 is divided into four in each field and is transferred. FIG. 7A shows ROM data, and FIGS. 7B to 7E show data transferred every field. The operation of the data transfer is similar to that in the case where the same data is divided into two in FIG. 6.

Thus, when data d2 same in every field is divided into a plurality of fields and is transferred, the ROM data can be transferred to LSI 21 even within a shorter vertical blanking time period.

In the example discussed above, the semiconductor integrated circuit has a terminal connected to both the display device and the flush memory, outputs video output data to the display device through the terminal, and transfers data between the control unit and the flush memory. Even when video data for driving the display device increases, the number of terminals of the LSI and the chip area can be prevented from increasing.

### INDUSTRIAL APPLICABILITY

The present invention can provide an image signal processing device that is suitable for improvement of the image quality and input of signals of various formats in a digital display device such as a plasma display.

1. An image signal processing device comprising:
a semiconductor integrated circuit having:
a video signal processing unit for outputting video output data to a display device; and
a control unit for holding data for controlling an operation of the video signal processing unit; and
an external memory that is disposed outside the semiconductor integrated circuit, holds control data to be fed to the control unit, and allows data read to be controlled by the control unit,
wherein data transferred between the external memory and the control unit has data that must be updated every field and data that does not need to be updated every field, and is transferred in a vertical blanking time period of the video output data, and
the data that does not need to be updated every field is divided into a plurality of data, assigned to a plurality of fields, and transferred.

2. The image signal processing device according to claim 1,
wherein the video signal processing unit has a memory for holding the data that must be updated every field and a memory for holding the data that does not need to be updated every field.
